(19) United States
(12) Patent Application Publication
(10) Pub. No.: US 2015/0274500 A1
(43) Pub. Date: Oct. 1, 2015

(54) WATER DISPENSER

(71) Applicant: KABUSHIKI KAISHA COSMO LIFE, Hyogo (JP)

(72) Inventor: Yoshinori Orita, Hyogo (JP)

(21) Appl. No.: 14/432,496

(22) PCT Filed: Aug. 20, 2013
(86) PCT No.: PCT/JP2013/072155

§ 371 Date: Mar. 31, 2015

(30) Foreign Application Priority Data
Oct. 19, 2012 (JP) 2012-231521

(51) Int. Cl. B67D 1/08; B67D 1/10; B67D 1/00

(52) U.S. Cl. CPC B67D 1/0801; B67D 1/0004; B67D 1/10

(57) ABSTRACT

A water dispenser includes a replaceable water bottle formed flexible so as to be collapsible as the amount of remaining water decreases; a bottle receiver having a bottle mounting plate configured to support the trunk portion of the water bottle from below, with the neck portion of the water bottle directed horizontally; a raw water pumping pipe connected to the water outlet port of the water bottle; and a pump provided in the raw water pumping pipe and configured to pump out the drinking water from the water bottle. A protrusion is provided on the upper surface of the bottle mounting board, and configured to induce a portion of the trunk portion of the water bottle in contact with the bottle mounting board to be folded inward when the water bottle is collapsed.

### TECHNICAL FIELD

The present invention relates to a water dispenser which supplies drinking water from a replaceable water bottle filled with drinking water such as mineral water.

### BACKGROUND ART

Conventionally, water dispensers have been used primarily in offices and in hospitals. With a growing interest in water safety and health in recent years, however, water dispensers are gaining popularity among ordinary households. A well-known example of such water dispensers is one in which a replaceable water bottle is set on the upper surface of a housing, so that drinking water filled in the water bottle falls down to a cold water tank housed in the housing with gravity, as described in the below-identified Patent document 1.

The water bottle of the above mentioned water dispenser comprises a hollow cylindrical trunk portion, a bottom portion provided at one end of the trunk portion, and a neck portion provided at the other end of the trunk portion through a shoulder portion; wherein the neck portion is provided with a water outlet port. This water bottle is set to the water dispenser with the neck portion of the water bottle facing downward such that the water outlet port is placed at the lowermost position of the water bottle. The trunk portion of the water bottle is formed flexible so as to be collapsible as the amount of remaining water decreases.

Since, in the water dispenser disclosed in Patent Document 1, the water bottle is set on the upper surface of the housing, a fully filled water bottle needs to be lifted high when replacing the water bottle. However, the fully filled water bottle usually contains drinking water of about 10 to 12 liters, weighing 10 kg or more. Therefore, replacement of the water bottle was a tough task for water dispenser users (for women and the elderly in particular).

In view of this, the inventors of the present invention have investigated for a water dispenser in which the water bottle is set at the lowest possible position in the water dispenser, in order to allow for an easy replacement of the water bottle. If the water bottle is placed at a lower position, there is no need to lift up the fully filled water bottle having a considerable weight when setting it to the water dispenser, and the replacement of the water bottle can be performed with ease.

### PRIOR ART REFERENCES

### Patent Documents

Patent Document 1: JP 2008-273605 A

### SUMMARY OF THE INVENTION

### Problems to be Solved by the Invention

When the water bottle is placed at the lower portion of the water dispenser, the position of the water bottle relative to that of the cold water tank becomes lower, making it difficult to supply the drinking water filled in the water bottle to the cold water tank by gravity fall. Therefore, in order to allow the supply of the drinking water from the water bottle to the cold water tank, the water dispenser needs to be provided with a pump for pumping out the drinking water from the water bottle.

The inventors of the present invention have focused on the fact that, if a water bottle which collapses as the amount of remaining water decreases is used, and if a pump for pumping out the drinking water from the water bottle is provided to the water dispenser, the water bottle can be set in the water dispenser in a position lying on its side (in other words, a position in which the neck portion of the water bottle is directed horizontally), because it eliminates the need to arrange the water bottle such that the water outlet port of the water bottle is placed at the lowermost position, as in the case where the gravity fall of the drinking water is utilized.

The arrangement of the water bottle in a position lying on its side allows for more freedom in the design of the water dispenser. For example, it allows for a configuration in which an end portion of a raw water pumping pipe is fixed within the housing of the water dispenser, a bottle receiver is supported horizontally slidably, and the sliding operation of the bottle receiver permits the water outlet port of the water bottle to be connected to the end portion of the raw water pumping pipe.

However, when the present inventors have carried out an experiment to pump out the drinking water in the water bottle mounted in a position lying on its side, in order to confirm if the arrangement of the water bottle in that position is actually feasible, it has been found that, when the drinking water in the water bottle is decreased and the water bottle is collapsed, the drinking water tends to remain in the region of the water bottle along the mounting surface, resulting in an increased amount of water left in the water bottle when the bottle is replaced. This problem is described in detail below.

As shown in FIG. 9, when a fully filled water bottle 4 is placed on a bottle mounting plate 54 having a flat upper surface, weight of the drinking water in the water bottle 4 causes the portion of a trunk portion 40 of the water bottle 4 in contact with the bottle mounting board 54 to be stretched. Thus, when the drinking water in the water bottle 4 is pumped out by a pump 7 to cause pressure reduction in the water bottle 4, the portion of the trunk portion 40 of the water bottle 4 in contact with the bottle mounting board 54 is not easily deformed. As a result, even when the water bottle 4 is collapsed, drinking water tends to remain in the water bottle 4 along the bottle mounting board 54, and the amount of water left in the water bottle 4 when the bottle is replaced is increased (the amount of remaining water may amount up to 400 to 500 cc).

In particular, this problem is more likely to occur if the water bottle is made of a polyethylene terephthalate resin (PET), which has a higher flexural modulus compared with a polyethylene resin (PE) and the like used for the bag of a bag-in-box.

An object of the present invention is to provide a water dispenser in which drinking water in the water bottle can be pumped as much as possible, leaving only a minimum amount, with the neck portion of the water bottle directed horizontally.

### Means for Solving the Problems

In order to solve the above mentioned problems, the present invention has adopted the following constitution.

A water dispenser comprising:

a replaceable water bottle comprising: a hollow cylindrical trunk portion formed flexible so as to be collapsible as an amount of water remaining in the water bottle decreases; a bottom portion provided at one end of the trunk portion; and a neck portion provided at the other end of the trunk portion through a shoulder portion; wherein the neck portion is provided with a water outlet port;

a bottle receiver having a bottle mounting plate configured to support the trunk portion of the water bottle from below, with the neck portion of the water bottle directed horizontally;

a raw water pumping pipe configured to be connected to the water outlet port of the water bottle; and

a pump provided in the raw water pumping pipe and configured to pump out drinking water from the water bottle;

wherein a protrusion is provided on the upper surface of the bottle mounting plate, the protrusion being configured to induce a portion of the trunk portion of the water bottle in contact with the bottle mounting plate to be folded inward when the water bottle is collapsed.

With this arrangement, when a fully filled water bottle is placed on the bottle mounting plate, the portion of the trunk portion of the water bottle in contact with the bottle mounting board is folded inward, and therefore not stretched, due to the presence of the protrusion. Thus, when the drinking water in the water bottle is pumped out by the pump, the portion of the trunk portion of the water bottle in contact with the bottle mounting board is deformed so as to be folded inward due to the pressure reduction in the water bottle. As a result, when the water bottle is collapsed, the drinking water is less likely to remain in the water bottle along the bottle mounting board, and it is possible to reduce the amount of the water left in the water bottle when the bottle is replaced.

As the above mentioned protrusion, for example, one formed to extend in the direction intersecting the middle of the trunk portion of the water bottle can be used.

Preferably, the protrusion has an upper surface formed with a slope sloping downward from the apex of the protrusion toward the water outlet port of the water bottle, and a slope sloping downward from the apex of the protrusion in the direction away from the water outlet port of the water bottle, such that the angle of inclination of the slope sloping downward from the apex of the protrusion toward the water outlet port of the water bottle is set to 30° or less. With this arrangement, when drinking water in the water bottle is pumped out from the water outlet port to cause the water bottle to collapse, it is possible to prevent a situation in which the deformed water bottle is caught on the protrusion and becomes unable to smoothly collapse.

The problem that a large amount of drinking water may remain in the water bottle along the bottle mounting plate when the water bottle is collapsed, is likely to occur particularly if the water bottle is made of a polyethylene terephthalate resin (PET) having a relatively high flexural modulus. Therefore, the present invention is particularly effective if the trunk portion of the water bottle is made of a PET resin.

### Effect of the Invention

In the water dispenser according to the present invention, when a fully filled water bottle is placed on the bottle mounting plate, the portion of the trunk portion of the water bottle in contact with the bottle mounting board is folded inward, and therefore not stretched, due to the presence of the protrusion. Thus, when drinking water in the water bottle is pumped out by the pump, the portion of the trunk portion of the water bottle in contact with the bottle mounting plate is deformed so as to be folded inward, due to the pressure reduction inside the water bottle. As a result, when the water bottle is collapsed, drinking water is less likely to remain in the water bottle along the bottle mounting board, thereby allowing the drinking water in the water bottle to be pumped out as much as possible, leaving only a minimum amount of water in the bottle.

### BRIEF DESCRIPTION OF THE DRAWINGS

FIG. 1 is a sectional view of a water dispenser embodying the present invention, seen from the side.

FIG. 2 is an enlarged sectional view of the water dispenser shown in FIG. 1, showing the vicinity of a bottle receiver.

FIG. 3 is a sectional view taken along the line of FIG. 2.

FIG. 4 is a view illustrating the state in which the bottle receiver shown in FIG. 2 has been pulled out of a housing.

FIG. 5 is an enlarged cross sectional view of the water dispenser shown in FIG. 2, showing the vicinity of a joint.

FIG. 6 is an enlarged cross sectional view illustrating the process of connecting a water bottle to the joint shown in FIG. 5.

FIG. 7 is an enlarged cross sectional view illustrating the state in which a plug body of a water outlet port of the water bottle is brought into contact with the joint shown in FIG. 6.

FIG. 8 is a view illustrating the process in which the water bottle shown in FIG. 2 gradually collapses.

FIG. 9 is a view illustrating the process in which the water bottle shown in FIG. 2 gradually collapses, in the case where a protrusion is not provided on the bottle receiver.

FIG. 10 is a sectional view of the water dispenser shown in FIG. 1 when it is in a sterilization operation mode.

FIG. 11 is a sectional view of another water dispenser that is different from the one shown in FIG. 1.

### MODE FOR CARRYING OUT THE INVENTION

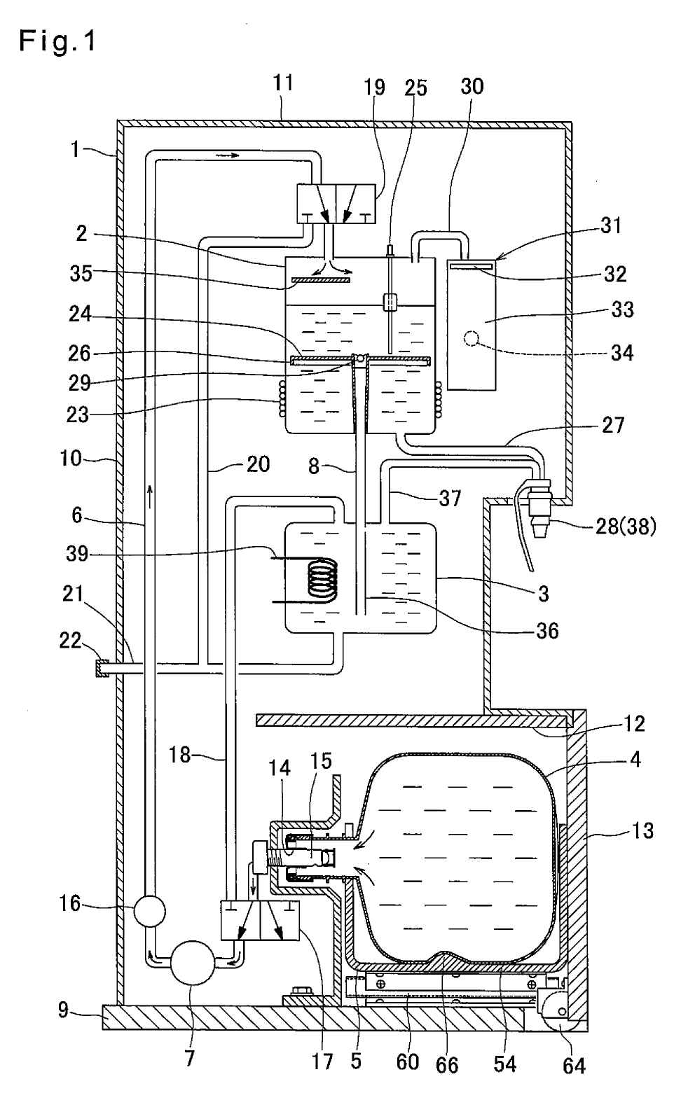

FIG. 1 shows a water dispenser embodying the present invention. This water dispenser comprises: a vertically elongated housing 1; a cold water tank 2 and a hot water tank 3 housed in the upper portion of the housing 1; a replaceable water bottle 4 housed in the lower portion of the housing 1; a bottle receiver 5 to which the water bottle 4 is mounted; a raw water pumping pipe 6 which communicates between the water bottle 4 and the cold water tank 2; a pump 7 provided in the raw water pumping pipe 6; and a tank connecting passage 8 connecting the cold water tank 2 to the hot water tank 3. The cold water tank 2 and the hot water tank 3 are arranged vertically such that the hot water tank 3 is positioned under the cold water tank 2.

The housing 1 comprises a bottom plate 9, a peripheral wall 10 rising from the periphery of the bottom plate 9, and a top plate 11 provided at the top end of the peripheral wall 10. The peripheral wall 10 has, at its lower portion of the front surface, an opening 12 through which the water bottle 4 can be moved into and out of the housing 1, and a front door 13 for opening and closing the opening 12.

One end of the raw water pumping pipe 6 is connected to a joint 15 configured to be inserted into and removed from a water outlet port 14 of the water bottle 4, and the other end of the raw water pumping pipe 6 is connected to the cold water tank 2. This raw water pumping pipe 6 extends downward from the joint 15 and is then redirected upward so that it passes through a position lower than the joint 15. The pump 7 is provided in the raw water pumping pipe 6 at a position lower than that of the joint 15.

The pump 7 transfers the drinking water inside the raw water pumping pipe 6 from the side of the water bottle 4 toward the cold water tank 2. A diaphragm pump can be used as the pump 7. While not shown, the diaphragm pump comprises a driving device for reciprocating a diaphragm; a pump chamber whose volume is increased and decreased by the reciprocation of the diaphragm; a suction side check valve provided at the suction port of the pump chamber and configured to allow only the flow into the pump chamber; and a discharge side check valve provided at a discharge port of the pump chamber and configured to allow only the flow out of the pump chamber.

A flow rate sensor 16 is provided in the raw water pumping pipe 6 at the discharge side of the pump 7. When the flow of the drinking water in the raw water pumping pipe 6 stops while the pump 7 is in operation, the flow rate sensor 16 is capable of detecting this fact.

A first switching valve 17 is provided in the raw water pumping pipe 6 at its portion between the joint 15 and the pump 7. Although the first switching valve 17 is placed at a position away from the joint 15 in the figures, the first switching valve 17 may be directly connected to the joint 15. A first bypass pipe 18 communicating with the hot water tank 3 is connected to the first switching valve 17. The end portion of the first bypass pipe 18 on the side of the hot water tank 3 is connected to the upper surface of the hot water tank 3.

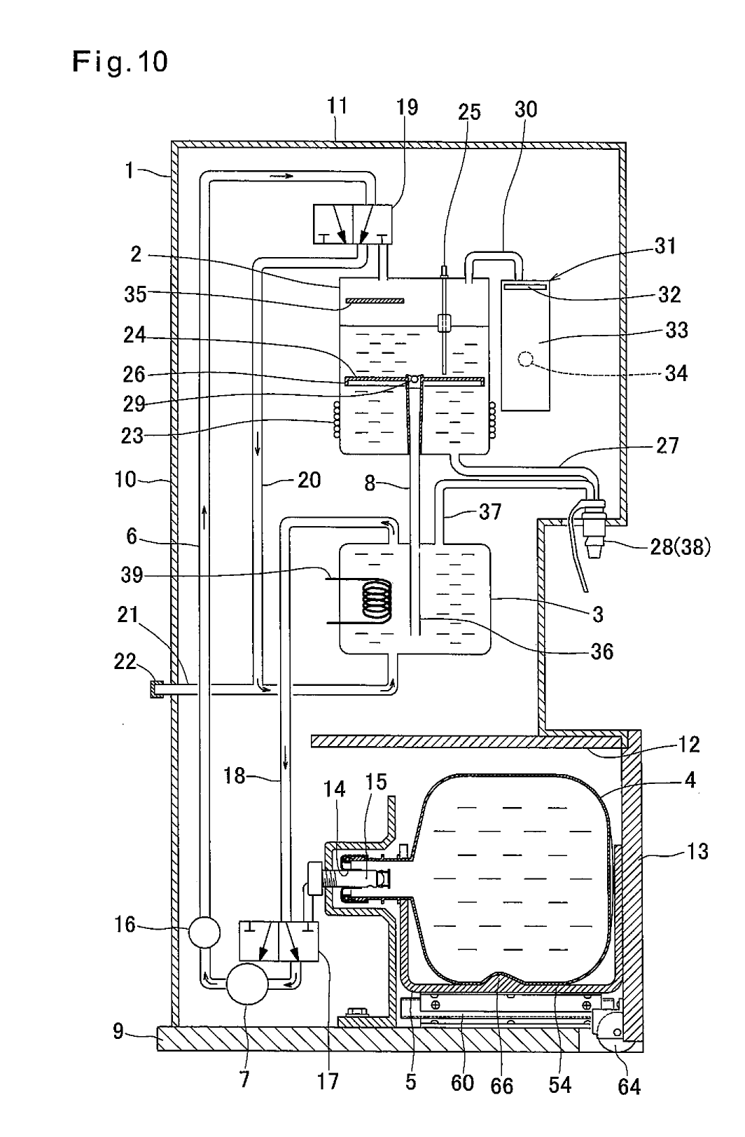

The first switching valve 17 is configured to be capable of switching the flow path between a normal operation mode (see FIG. 1) and a sterilization operation mode (see FIG. 10). In the normal operation mode, the first switching valve 17 allows communicating between the joint 15 and the pump 7, while blocking communication between the first bypass pipe 18 and the pump 7; and in the sterilization operation mode, the first switching valve 17 blocks communication between the joint 15 and the pump 7, and allows communication between the first bypass pipe 18 and the pump 7.

A second switching valve 19 is provided at the end portion of the raw water pumping pipe 6 on the side of the cold water tank 2, and is configured to sterilize hot water. A second bypass pipe 20 is connected to the second switching valve 19 and communicates with the hot water tank 3. The end portion of the second bypass pipe 20 on the side of the hot water tank 3 is connected to the lower surface of the hot water tank 3. Further, a drain pipe 21 is connected to the second bypass pipe 20 and extends to the exterior of the housing 1. The exit of the drain pipe 21 is closed with a plug 22. An on-off valve may be provided instead of the plug 22.

The second switching valve 19 is configured to be capable of switching the flow path between a normal operation mode (see FIG. 1) and a sterilization operation mode (see FIG. 10). In the normal operation mode, the second switching valve 19 allows communication between the raw water pumping pipe 6 and the cold water tank 2, and blocks communication between the raw water pumping pipe 6 and the second bypass pipe 20; and in the sterilization operation mode, the second switching valve 19 blocks communication between the raw water pumping pipe 6 and the cold water tank 2, and allows communication between the raw water pumping pipe 6 and the second bypass pipe 20.

Although each of the first switching valve 17 and the second switching valve 19 is illustrated as a single, three-way valve in the figures, a plurality of on-off valves may be used in combination to achieve the same effect.

The cold water tank 2 contains air and drinking water in upper and lower layers. A cooling device 23 is attached to the cold water tank 2, and is configured to cool the drinking water contained in the cold water tank 2. Further, a baffle plate 24 is provided inside the cold water tank 2 and partitions the interior of the cold water tank 2 into upper and lower sections. The cooling device 23 is positioned at the lower outer periphery of the cold water tank 2, so that the drinking water inside the cold water tank 2 below the baffle plate 24 is maintained at low temperature (about 5 degrees Celsius).

A water level sensor 25 is installed to the cold water tank 2 and configured to detect the water level of the drinking water accumulated in the cold water tank 2. When the water level detected by the water level sensor 25 falls to a predetermined level, the pump 7 is actuated, and drinking water is supplied from the water bottle 4 to the cold water tank 2. The baffle plate 24 prevents the drinking water cooled by the cooling device 23 and accumulated in the lower portion of the cold water tank 2 from being stirred by the normal-temperature drinking water supplied from the water bottle 4 into the cold water tank 2, when the latter is supplied from the water bottle 4 to the cold water tank 2. The baffle plate 24 has a cylindrical suspended wall 26 extending downward from the outer peripheral edge of the baffle plate 24. By holding air in the space surrounded by the suspended wall 26, the insulation effect between the portions above and beneath the baffle plate 24 improves.

A cold water discharge passage 27 is connected to the bottom surface of the cold water tank 2 such that low-temperature drinking water accumulated in the lower portion of the cold water tank 2 can be discharged to the outside through the cold water discharge passage 27. The cold water discharge passage 27 is provided with a cold water cock 28 capable of being operated from outside the housing 1, so that low temperature drinking water can be discharged from the cold water tank 2 into a cup or the like by opening the cold water cock 28. The capacity of the cold water tank 2 is lower than that of the water bottle 4, and is about from 2 to 4 liters.

A tank connecting passage 8 connecting the cold water tank 2 and the hot water tank 3 has a top end opening at the center of the baffle plate 24. A check valve 29 is provided at the end portion of the tank connecting passage 8 on the side of the cold water tank 2. The check valve 29 permits the flow of drinking water from the side of the cold water tank 2 toward the hot water tank 3, and restricts the flow of drinking water from the side of the hot water tank 3 toward the cold water tank 2. The check valve 29 prevents the loss of energy in the cold water tank 2 and the hot water tank 3, by preventing the high-temperature drinking water in the hot water tank 3 from flowing into cold water tank 2 due to heat convection.

The hot water tank 3 is filled with drinking water. A heating device 39 is mounted to the hot water tank 3, and is configured to heat the drinking water in the hot water tank 3 so that the drinking water in the hot water tank 3 is maintained at a high temperature (about 90° C.). While an example in which a sheathed heater is used as the heating device 39 is shown in the figures, a band heater may be used instead. The sheathed heater is a heating device including a heating wire housed in a metal pipe and configured to generate heat when energized, and is installed to extend through the wall of the hot water tank 3 and into the interior of the hot water tank 3. The band heater is a cylindrical heat generator in which a heating wire which generates heat when energized is embedded, and is tightly attached around the outer periphery of the hot water tank 3.

An air sterilization chamber 31 is connected to the cold water tank 2 through an air introducing passage 30. The air sterilization chamber 31 comprises a hollow casing 33 in which an air inlet port 32 is formed, and an ozone generator 34 provided within the casing 33. The ozone generator 34 may be, for example, a low-pressure mercury lamp which irradiates ultraviolet light to the oxygen in the air to convert oxygen to ozone, or a silent discharge apparatus which applies an AC voltage between an opposed pair of electrodes covered with insulators to convert oxygen between the electrodes to ozone. The air sterilization chamber 31 is maintained in a state in which the casing 33 is constantly filled with ozone, by energizing the ozone generator 34 at regular intervals to generate ozone.

When the water level in the cold water tank 2 decreases, air is introduced into the cold water tank 2 through the air introduction passage 30 such that the pressure in the cold water tank 2 is maintained at atmospheric pressure. Since air introduced into the cold water tank 2 is sterilized with ozone by passing through the air sterilization chamber 31, the air inside the cold water tank 2 is maintained clean.

A diffuser plate 35 is provided in the cold water tank 2. The diffuser plate 35 is configured to diffuse the flow of drinking water transferred from the raw water pumping pipe 6 until it reaches the water surface of the drinking water accumulated in the cold water tank 2. The diffuser plate 35 increases the contact area between the drinking water and ozone contained in the air in the cold water tank 2 (i.e., ozone flowing into the cold water tank 2 through the air sterilization chamber 31), thereby improving the sanitation of the drinking water in the cold water tank 2.

The tank connecting passage 8 includes an in-tank pipe portion 36 extending downward from the upper surface of the hot water tank 3 through the interior of the hot water tank 3. The in-tank pipe portion 36 has an open lower end near the bottom surface of the hot water tank 3, thereby preventing the ascending flow of high temperature drinking water heated by the heating device 39 from directly flowing into the in-tank pipe portion 36 through the open lower end thereof.

A hot water discharge passage 37 is connected to the upper surface of the hot water tank 3 such that high temperature drinking water accumulated in the upper portion of the hot water tank 3 can be discharged to the outside through the hot water discharge passage 37. The hot water discharge passage 37 is provided with a hot water cock 38 capable of being operated from outside the housing 1, so that high temperature drinking water can be discharged from the hot water tank 3 into a cup or the like by opening the hot water cock 38. When drinking water is discharged from the hot water tank 3, the same amount of drinking water as the discharged drinking water flows into the hot water tank 3 from the cold water tank 2 through the tank connecting passage 8, so that the hot water tank 3 is constantly maintained fully filled. The capacity of the hot water tank 3 is about from 1 to 2 liters.

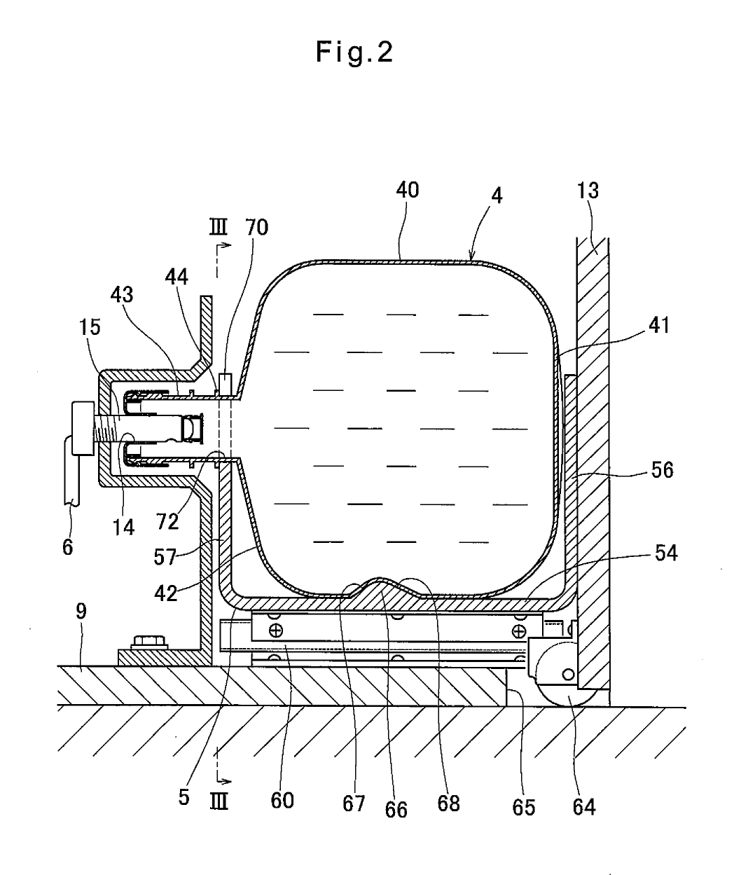

As shown in FIG. 2, the water bottle 4 includes a hollow cylindrical trunk portion 40, a bottom portion 41 provided at one end of the trunk portion 40, and a neck portion 43 provided at the other end of the trunk portion 40 through a shoulder portion 42. The neck portion 43 is provided with a water outlet port 14. A flange 44 is formed at the outer periphery of the neck portion 43. The trunk portion 40 of the water bottle 4 is formed flexible so that the water bottle 4 collapses as the amount of water remaining in the bottle 4 decreases. The water bottle 4 is formed by blow molding of polyethylene terephthalate (PET) resin. The capacity of the water bottle 4 is from 10 to 20 liters when the bottle is fully filled.

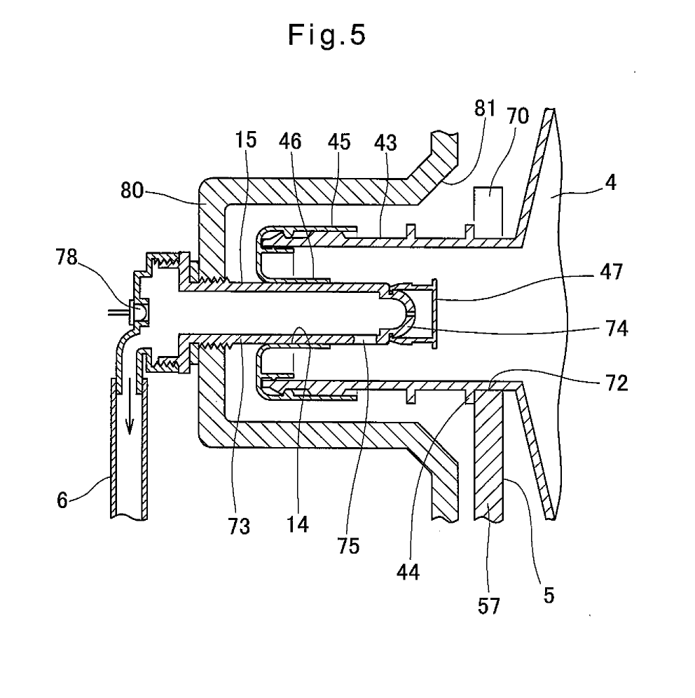

As shown in FIG. 5, a cap 45 is attached to the tip of the neck portion 43 of the water bottle 4. An inner tube 46 is formed at the center of the cap 45. The inner tube 46 extends in parallel with the neck portion 43 toward the interior of the water bottle 4, and opens at its both ends. The inner space of the inner tube 46 forms the water outlet port 14 of the water bottle 4, and a plug 47 is fitted detachably in the water outlet port 14. The cap 45 is formed by injection molding of polyethylene (PE) resin.

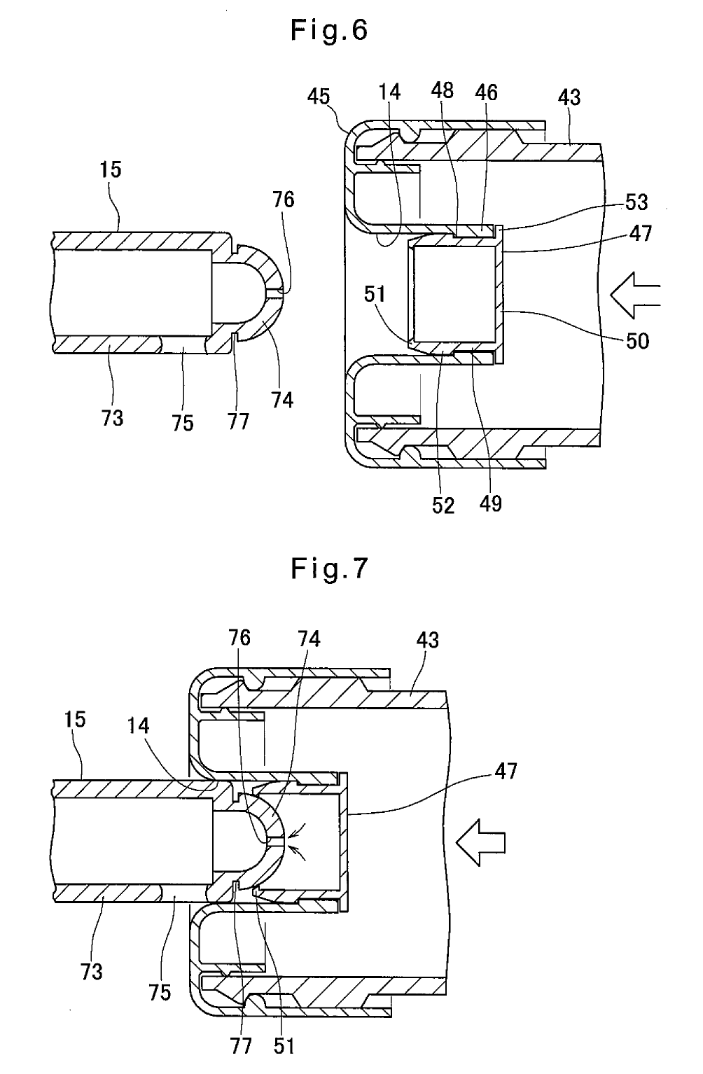

As shown in FIG. 6, a stepped portion 48 is formed on the inner peripheral surface of the inner tube 46 such that the inner peripheral surface of the inner tube 46 has a smaller diameter at its portion closer to the interior of the water bottle 4. The plug 47 is a cylindrical member including a cylindrical portion 49, a closed end portion 50 formed at one end of the cylindrical portion 49, and a claw portion 51 formed along the inner periphery of the other end of the cylindrical portion 49. The plug 47 is fitted to the inner tube 46, with its opening facing toward the exterior of the water bottle 4. A projection 52 is formed on the outer peripheral surface of the cylindrical portion 49 and engages with the stepped portion 48 of the inner tube 46. An opposed piece 53 is formed at the end portion of the cylindrical portion 49 on the side of the interior of the water bottle 4, and faces the end portion of the inner tube 46 in the axial direction.

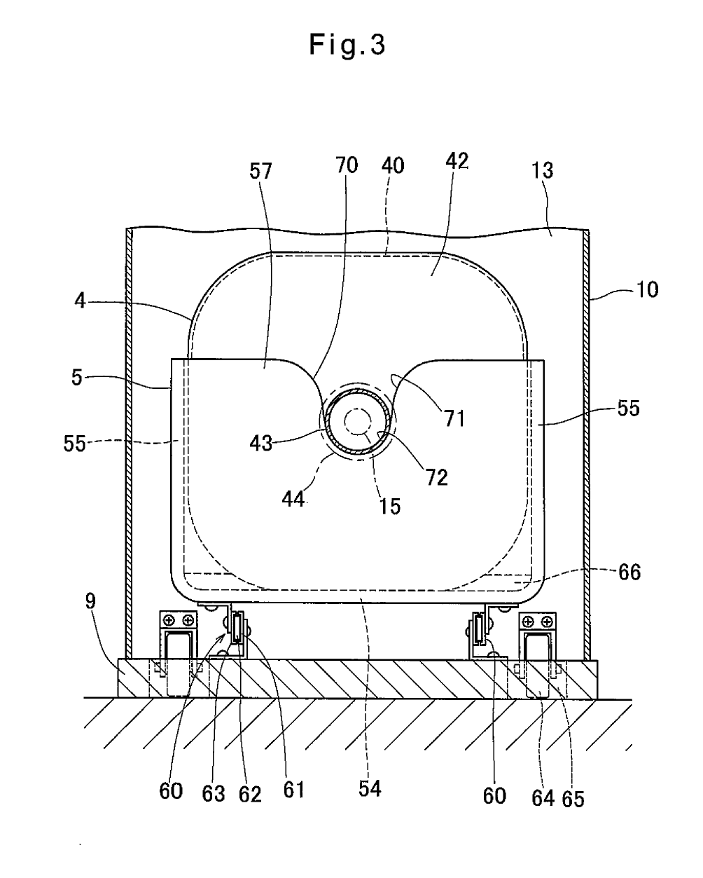

As shown in FIG. 2 and FIG. 3, the trunk portion 40 of the water bottle 4 is in the shape of square tube having a rectangular cross section. The bottle receiver 5 includes a bottle mounting plate 54 for supporting the water bottle 4 from below, side plates 55 positioned on both sides of the water bottle 4, a front plate 56 positioned forward of the water bottle 4, and a rear plate 57 positioned rearward of the water bottle 4. As used herein, the reference of forward and rearward is based on the direction seen from a user standing facing the water dispenser. That is, the side of the water dispenser closer to the user is referred to as “forward”, and the side farther from the user is referred to as “rearward”. The bottle receiver 5 is supported by a right and left pair of slide rails 60 extending in the forward and rearward direction.

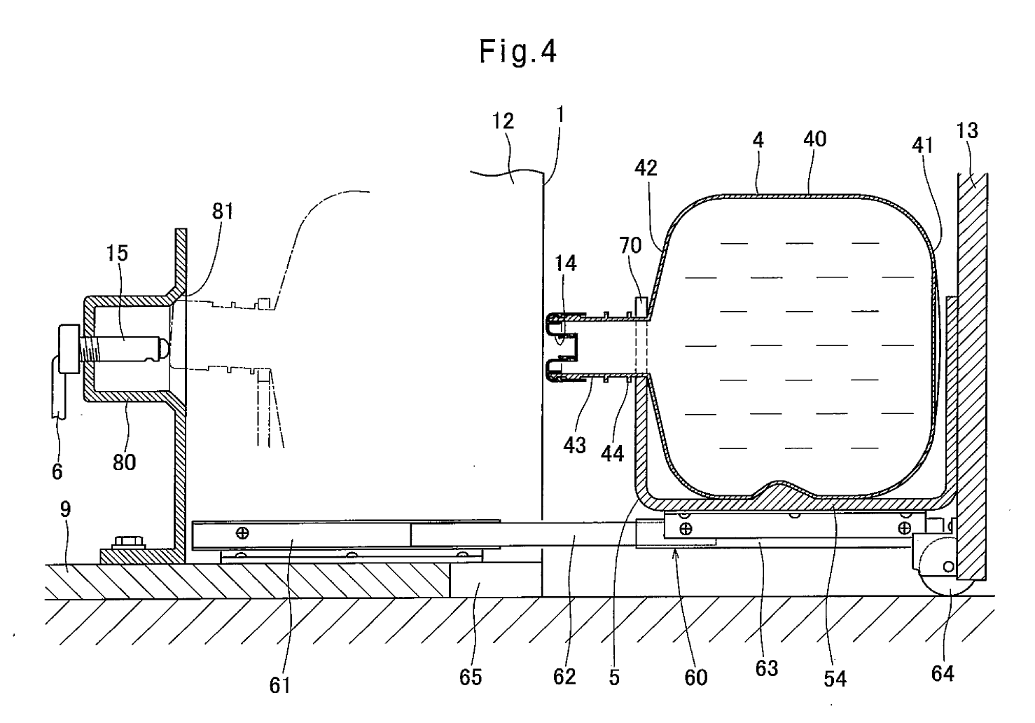

As shown in FIG. 4, each of the slide rails 60 comprises a fixed rail member 61 fixed to the bottom plate 9 of the housing 1, an intermediate rail member 62 slidably supported by the fixed rail member 61, and a movable rail member 63 slidably supported by the intermediate rail member 62. The movable rail members 63 are fixed to the bottle mounting plate 54 of the bottle receiver 5. The bottle receiver 5 is configured to be horizontally movable between a stowed position (the position shown in FIG. 2) in which the water bottle 4 is stowed inside the housing 1, and a pulled out position (the position shown in FIG. 4) in which the water bottle 4 is moved out of the housing 1, by the relative sliding movements of the three rail members 61, 62, and 63 constituting each of the slide rails 60.

The water bottle 4 is mounted on the bottle receiver 5, with the water outlet port 14 of the water bottle 4 facing the direction in which the bottle receiver 5 moves (i.e., the rearward in this context), when it is moved from the pulled out position to the stowed position of the bottle receiver 5. The water bottle 4 is mounted with the neck portion 43 directed horizontally.

The joint 15 is fixed inside the housing 1 such that it is disconnected from the water outlet port 14 of the water bottle 4 when the bottle receiver 5 has been moved to the pulled out position, as shown in FIG. 4, and it is connected to the water outlet port 14 of the water bottle 4 when the bottle receiver 5 has been moved to the stowed position, as shown in FIG. 2.

The front door 13 of the housing 1 is fixed to the bottle receiver 5 so that the front door 13 slides together with the bottle receiver 5. Thus, when the front door 13 is pulled forward to open the opening 12, the bottle receiver 5 is pulled out of the housing 1 at the same time. When the front door 13 is pushed backward to close the opening 12, the bottle receiver 5 is stowed inside the housing 1.

Wheels 64 are attached to the lower portion of the front door 13 so as to be kept in rolling contact with the surface on which the housing 1 is placed. When the bottle receiver 5 is pulled out of the housing 1 and a load (such as the weight of a fully filled water bottle 4 and/or the weight of a person) acts on the bottle receiver 5, the wheels 64 prevent the housing 1 from falling by supporting the load. Recesses 65 for stowing the wheels 64 are formed in the bottom plate 9 of the housing 1.

As shown in FIG. 2, a protrusion 66 is provided on the upper surface of the bottle mounting board 54, and extends in the direction intersecting the middle of the trunk portion 40 of the water bottle 4. The upper surface of the protrusion 66 is formed with a slope 67 sloping downward from the apex of the protrusion 66 toward the water outlet port 14, and a slope 68 sloping downward from the apex of the protrusion 66 in the direction away from the water outlet port 14. The slope 68 on the side opposite from the water outlet port 14 is less steep than the slope 67 on the side of the water outlet port 14, and has an inclination angle of 30° or less.

As shown in FIG. 3, the rear plate 57 of the bottle receiver 5 is provided with a notch 70 opening to the upper edge of the rear plate 57. The notch 70 comprises an introduction portion 71 narrowing gradually downwardly from the upper edge of the rear plate 57, and a semicircular restricting portion 72 contiguous to the lower side of the introduction portion 71, and configured to fit to the outer periphery of the neck portion 43 of the water bottle 4. The restricting portion 72 is fitted to the portion of the neck portion 43 closer to the trunk portion 40 than is the flange 44.

The restricting portion 72 is formed into a circular arc shape having a diameter smaller than the outer diameter of the flange 44 of the neck portion 43 of the water bottle 4. The restricting portion 72 is fitted to the outer periphery of the neck portion 43 to fix the position of the neck portion 43 in the radial direction, thereby preventing the position of the water outlet port 14 of the water bottle 4 from being displaced from the position of the joint 15, when the water bottle 4 is connected to the joint 15. Further, as shown in FIG. 2, the restricting portion 72 engages with the flange 44 of the neck portion 43 to fix the position of the neck portion 43 in the axial direction, thereby restricting the movement of the water outlet port 14 of the water bottle 4 in the direction in which it is disconnected from the joint 15.

As shown in FIG. 5, the joint 15 is a tubular member extending horizontally and configured to be fitted to the water outlet port 14 of the water bottle 4. The joint 15 includes a straight portion 73 having a cylindrical outer periphery and a hemispherical tip portion 74. The diameter of the straight portion 73 is determined such that the straight portion 73 can be fitted to the water outlet port 14 of the water bottle 4 (that is, the inner tube 46) with an interference fit. The straight portion 73 is provided with a water flow hole 75 configured to open to the interior of the water bottle 4 when the joint 15 is fitted to the water outlet port 14 of the water bottle 4. The water flow hole 75 is entirely provided only in the lower half portion of the joint 15, and not in the upper half portion thereof.

As shown in FIG. 6 and FIG. 7, a through hole 76 is formed through the center of the tip portion 74 to communicate with the interior and the exterior of the joint 15. The diameter of the through hole 76 is set to 1.0 mm or less. Further, a circumferential groove 77 is formed on the outer periphery of the joint 15 at the boundary between the straight portion 73 and the tip portion 74 such that the claw portion 51 of the plug 47 is engageable in the circumferential groove 77.

As shown in FIG. 5, an ultraviolet light emitting device 78 is provided at the base of the joint 15. The ultraviolet light emitting device 78 irradiates ultraviolet rays to the drinking water inside the joint 15 and the inner surface of the joint 15 to carry out sterilization. An ultraviolet LED or a mercury lamp can be used as the ultraviolet light emitting device 78.

The joint 15 is fixed to a cup member 80 surrounding the joint 15. The cup member 80 is a tubular member having a bottom portion and opens toward the water bottle 4, and the joint 15 extends through the bottom portion of the cup member 80. A tapered surface 81 is formed at the opening edge of the cup member 80. The diameter of the tapered surface 81 increases toward the direction of the water bottle 4. The tapered surface 81 guides the neck portion 43 toward the position of the joint 15, even if, as shown by the chain line in FIG. 4, the neck portion 43 of the water bottle 4 is not accurately in alignment with the joint 15 when stowing the water bottle 4 into the housing 1.

As the raw water pumping pipe 6, a silicon tube can be used. However, since silicon has an oxygen permeability, proliferation of bacteria is more likely to occur in the raw water pumping pipe 6 due to the oxygen in the air that permeates through the silicon tube. Therefore, a metal pipe (such as a stainless steel pipe or a copper pipe) can be used as the raw water pumping pipe 6. With this arrangement, permeation of air through the wall of the raw water pumping pipe 6 can be prevented, thereby allowing effective prevention of the proliferation of bacteria in the raw water pumping pipe 6. In addition, heat resistance during the circulation of hot water can also be secured. By using a polyethylene tube or a heat-resistant, rigid polyvinyl chloride tube as the raw water pumping pipe 6 too, it is possible to prevent the permeation of air through the pipe wall of the raw water pumping pipe 6, thereby preventing the proliferation of bacteria in the raw water pumping pipe 6.

It is now described how the above described water dispenser is used.

In the normal operation mode shown in FIG. 1, when a user of the water dispenser operates the cold water cock 28 to discharge low temperature drinking water in the cold water tank 2 into a cup or the like, the water level in the cold water tank 2 falls. Further, when the user operates the hot water cock 38 to discharge high temperature drinking water in the hot water tank 3 into a cup or the like, the water level inside the cold water tank 2 also falls, because the same amount of drinking water as the discharged high temperature drinking water is introduced from the cold water tank 2 into the hot water tank 3 through the tank connecting passage 8. When the water level sensor 25 detects that the water level in the cold water tank 2 is below a predetermined lower limit water level, the pump 7 is actuated and pumps up drinking water from the water bottle 4 to the cold water tank 2.

As drinking water in the cold water tank 2 or the hot water tank 3 is used, the drinking water in the water bottle 4 gradually decreases and the bottle 4 eventually becomes empty. When the water bottle 4 becomes empty, the flow of drinking water in the raw water pumping pipe 6 stops even though the pump 7 is in operation. When the flow rate sensor 16 detects this situation, a bottle replacement-lamp placed on the front surface of the housing 1 is turned on to notify the user that the water bottle 4 needs to be replaced.

When the water bottle 4 becomes empty, the user replaces the water bottle 4 as follows. First, as shown in FIG. 4, the front door 13 is pulled forward to move the bottle receiver 5 out of the housing 1. At this time, the water bottle 4 is disconnected from the joint 15 fixed inside the housing 1, since the water bottle 4 moves together with the bottle receiver 5. Then the empty water bottle 4 is removed from the bottle receiver 5. A fully filled water bottle 4 is then placed on the bottle receiver 5 with the neck portion 43 of the water bottle 4 facing sideways such that the neck portion 43 of the water bottle 4 is fitted in the notch 70 of the bottle receiver 5. Finally, the front door 13 is pushed back to stow the bottle receiver 5 into the housing 1. At this time, since the water bottle 4 moves together with the bottle receiver 5, the water bottle 4 is connected to the joint 15 fixed within the housing 1.

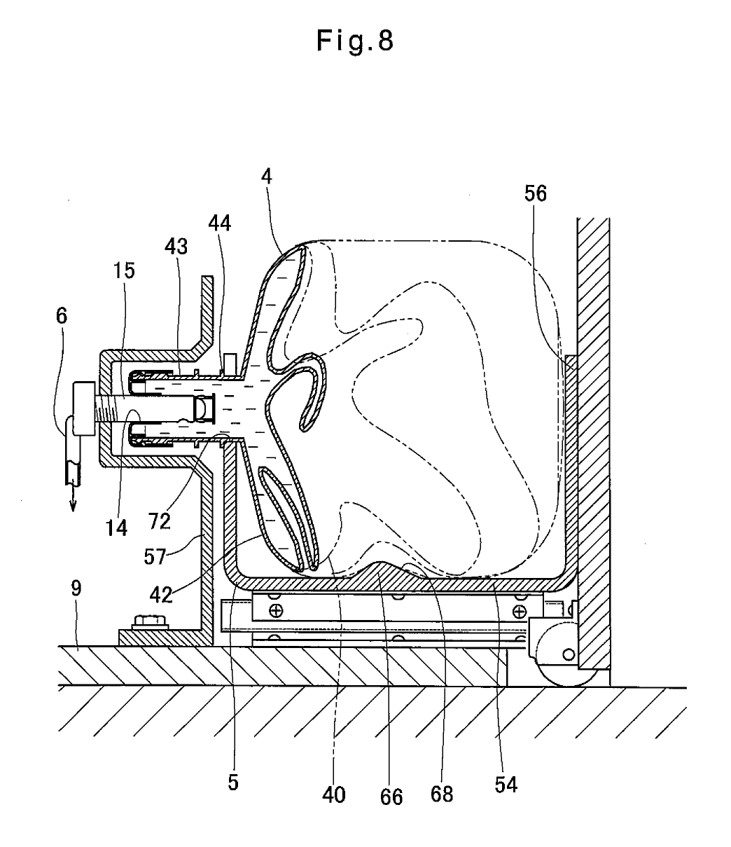

As shown in FIG. 8, the water bottle 4 collapses due to atmospheric pressure, as the drinking water inside the bottle is pumped out by the pump 7. When the water bottle 4 collapses, the protrusion 66 provided on the bottle mounting plate 54 of the bottle receiver 5 of the above mentioned water dispenser tends to deform the portion of the trunk portion 40 of the water bottle 4 in contact with the bottle mounting board 54 so as to be folded inwardly. This allows the drinking water in the water bottle 4 to be pumped out as much as possible, leaving only a minimum amount of water in the bottle.

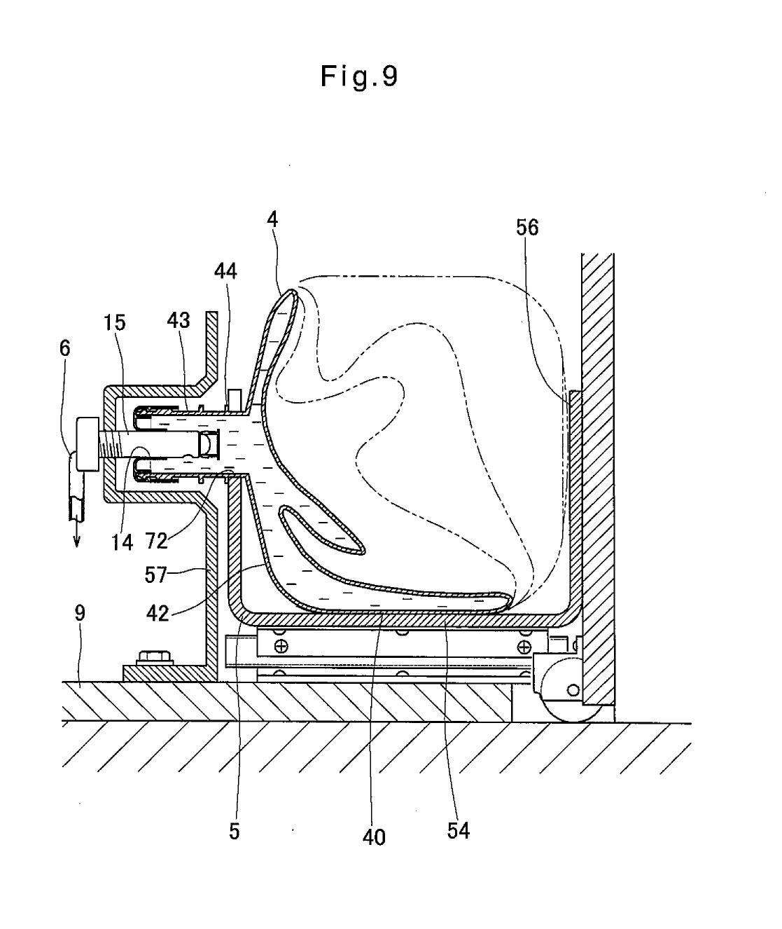

If, as shown in FIG. 9, the upper surface of the bottle mounting plate 54 is formed flat without providing the protrusion 66, when a fully filled water bottle 4 is placed on the bottle mounting plate 54, the weight of the drinking water inside the water bottle 4 causes the portion of the trunk portion 40 of the water bottle 4 in contact with the bottle mounting plate 54 to stretch. Therefore, even when the drinking water in the water bottle 4 is pumped out by the pump 7 to cause the pressure reduction inside the water bottle 4, the portion of the trunk portion 40 of the water bottle 4 in contact with the bottle mounting board 54 is not easily deformed. Further, the shoulder portion 42 of the water bottle 4 is also not easily deformed, because the neck portion 43 is restricted by the restricting portion 72 of the rear plate 57. As a result, when the water bottle 4 collapses, as illustrated by the chain line shown in FIG. 9, the upper side portion and the bottom portion 41 of the trunk portion 40 of the water bottle 4 are deformed preferentially. This leads to the problem that, when the water bottle 4 collapses, a large space filled with drinking water tends to remain in the water bottle 4 along the bottle mounting plate 54, resulting in an increased amount of water left in the water bottle 4 when the bottle is replaced (the amount of remaining water may amount up to about 400 to 500 cc).

In contrast, by providing the protrusion 66 on the bottle mounting plate 54 of the bottle receiver 5 as shown in FIG. 8, when a fully filled water bottle 4 is placed on the bottle receiver 5, the portion of the trunk portion 40 of the water bottle 4 in contact with the bottle mounting board 54 is folded along the protrusion 66, and not stretched. Thus, when the drinking water in the water bottle 4 is pumped out by the pump 7, the portion of the trunk portion 40 of the water bottle 4 in contact with the bottle mounting board 54 is deformed so as to be folded inward, due to the pressure reduction inside the water bottle 4 (see the chain line shown in FIG. 8). As a result, drinking water is less likely to remain in the portion of the water bottle 4 in contact with the bottle mounting board 54 when the water bottle 4 is collapsed, thereby allowing the reduction of the amount of water left in the water bottle 4 when the water bottle 4 is replaced.

When the water bottle 4 is collapsed, there are possibilities that the water bottle 4 could get caught on the protrusion 66, and thereby become unable to smoothly collapse. However, in the above mentioned embodiment, the situation in which the water bottle 4 gets caught on the protrusion 66 is prevented by forming the slope 68 of the protrusion 66 less steeply.

Further, in the above mentioned water dispenser, the water bottle 4 is disconnected from the end portion of the raw water pumping pipe 6 when the bottle receiver 5 is pulled out of the housing 1, and the water bottle 4 is connected to the end portion of the raw water pumping pipe 6 when the bottle receiver 5 is stowed in the housing 1. In other words, it is not necessary to configure the raw water pumping pipe 6 to follow the movement of the bottle receiver 5. As a result, the length of the raw water pumping pipe 6 can be made short, thereby preventing the proliferation of bacteria in the raw water pumping pipe 6.

Since, in the above mentioned water dispenser, the raw water pumping pipe 6 is not required to follow the movement of the bottle receiver 5, it is not necessary to use a spiral tube or a flexible tube for the raw water pumping pipe 6, and a rigid one can be used as the raw water pumping pipe 6. Thus, a metal pipe (such as a stainless steel pipe and a copper pipe) excellent in oxygen barrier properties and heat resistance can be used as the raw water pumping pipe 6.

In addition, in the above mentioned water dispenser, it is possible to sterilize the raw water pumping pipe 6 and to secure the sanitation of the water dispenser for a long period of time, by performing sterilization operation regularly. The sterilization operation of the water dispenser will be described below.

First, as shown in FIG. 10, the first switching valve 17 is switched to allow communication between the first bypass pipe 18 and the pump 7, and the second switching valve 19 is switched to allow communication between the raw water pumping pipe 6 and the second bypass pipe 20. Then, the pump 7 is actuated. This allows high temperature drinking water in the hot water tank 3 to pass through the first bypass pipe 18, the first switching valve 17, the raw water pumping pipe 6, the second switching valve 19, and the second bypass pipe 20, sequentially, and to return to the hot water tank 3. In other words, high temperature drinking water in the hot water tank 3 circulates through the raw water pumping pipe 6. By energizing the heating device 39 of the hot water tank 3 at this time, it is possible to keep the temperature of the circulating drinking water at high temperature suitable for sterilization. Thus, the drinking water inside the raw water pumping pipe 6, the inner surface of the raw water pumping pipe 6, and the interior of the pump 7 can be sterilized by heat.

After the completion of the sterilization operation, the pump 7 is stopped and the first switching valve 17 is switched to allow communication between the joint 15 and the pump 7, and the second switching valve 19 is switched to allow communication between the raw water pumping pipe 6 and the cold water tank 2, as shown in FIG. 1, to return to the normal operation mode.

After the completion of the sterilization operation and before returning to the normal operation mode, the first switching valve 17 can be switched to the sterilization operation mode to allow communication between the first bypass pipe 18 and the pump 7, while the second switching valve 19 can be switched to the normal operation mode to allow communication between the raw water pumping pipe 6 and the cold water tank 2; and the pump 7 can be actuated for a predetermined period of time in this state. With this arrangement, high temperature drinking water flows from the raw water pumping pipe 6 into the cold water tank 2, thereby allowing the sterilization of the portion of the raw water pumping pipe 6 between the second switching valve 19 and the cold water tank 2. At this time, a predetermined amount of high temperature drinking water flows into the cold water tank 2. However, the baffle plate 24 prevents the drinking water in the cold water tank 2 from being stirred, and air surrounded by the suspended wall 26 of the baffle plate 24 prevents the heat transfer from the upper side to the lower side of the baffle plate 24, and thus the drinking water accumulated in the lower portion of the cold water tank 2 can be maintained at a low temperature.

By regularly performing the sterilization operation as described above, it is possible to sterilize the raw water pumping pipe 6, through which the normal temperature drinking water flows during the normal operation, and to secure the sanitation of the water dispenser for a long period of time.

If a type of water bottle formed rigid overall is used as the water bottle 4, and when the water bottle 4 is placed with the water outlet port 14 of the water bottle 4 directed horizontally, it becomes difficult to pump out the drinking water in the water bottle 4 by the pump 7. In contrast, if a water bottle formed flexible so as to be collapsible as the amount of water remaining in the water bottle decreases is used as the water bottle 4, as in the case of the above mentioned water dispenser, the drinking water in the water bottle 4 can be pumped out by the pump 7 even when the water bottle 4 is placed with the water outlet port 14 of the water bottle 4 directed horizontally.

In the above mentioned water dispenser, since the movement of the water outlet port 14 of the water bottle 4 is restricted by the restricting portion 72 of the bottle receiver 5, when the water outlet port 14 of the water bottle 4 is connected to the joint 15, it is possible to prevent the situation where the position of the water outlet port 14 becomes unstable by the deformation of the water bottle 4 which is formed flexible.

Further, in the above mentioned water dispenser, the raw water pumping pipe 6 is provided such that it passes through a position lower than the position of the joint 15, and the pump 7 is placed at the portion of the raw water pumping pipe 6 lower than the position of the joint 15. Therefore, when the water outlet port 14 of the water bottle 4 is disconnected from the joint 15, it is possible to prevent the drinking water remaining in the raw water pumping pipe 6 from flowing out of the joint 15 due to its own weight.

In addition, since the water flow hole 75 of the joint 15 of the above mentioned water dispenser is positioned at a relatively low position in the joint 15 (in the bottom half region), it is possible to pump out the drinking water in the water bottle as much as possible, even when the amount of drinking water left in the water bottle 4 is decreased. Besides, since the water flow hole 75 does not exist in the upper half portion of the joint 15, it is possible to prevent air from flowing into the interior of the joint 15, and to prevent drinking water inside the joint 15 from flowing out, when the water bottle 4 is disconnected from the joint 15.

Further, in the above mentioned water dispenser, the through hole 76 is formed at the tip of the joint 15. Therefore, as shown in FIG. 6 and FIG. 7, when the plug 47 is fitted to the tip portion 74 of the joint 15, air enclosed in the space between the plug 47 and the tip portion 74 escapes into the joint 15 via the through hole 76. This allows the plug 47 to be smoothly fitted to the tip portion 74 of the joint 15.

If the diameter of the through hole 76 is set to 1.0 mm or less, more preferably, 0.8 mm or less, when the water bottle 4 is disconnected from the joint 15, it is possible to prevent air from flowing into the interior of the joint 15 via the through hole 76 by the surface tension of the water, and to prevent drinking water inside the joint 15 from flowing out through the water flow hole 75.

In the above mentioned water dispenser, the tapered surface 81 for guiding the neck portion 43 of the water bottle 4 toward the joint 15 is provided around the joint 15, and therefore, the connecting operation can be performed reliably when the water bottle 4 is connected to the joint 15.

Although the flange 44 is formed at the neck portion 43 of the water bottle 4 in the above mentioned embodiment, the flange 44 can be formed on the cap 45 which is attached to the neck portion 43. Alternatively, the flange may not be formed on the neck portion 43 of the water bottle 4, and a clamping means to hold the neck portion 43 can be provided to the bottle receiver 5 instead, and the clamping means can be used to restrict the movement of the water outlet port 14 of the water bottle 4.

If the bottle receiver 5 is configured to be moved into and out of the housing 1 in the forward and backward direction as in the above mentioned embodiment, the installation space of the water dispenser can be reduced. However, it is also possible to configure the bottle receiver 5 so as to be movable into and out of the housing 1 in the right and left direction.

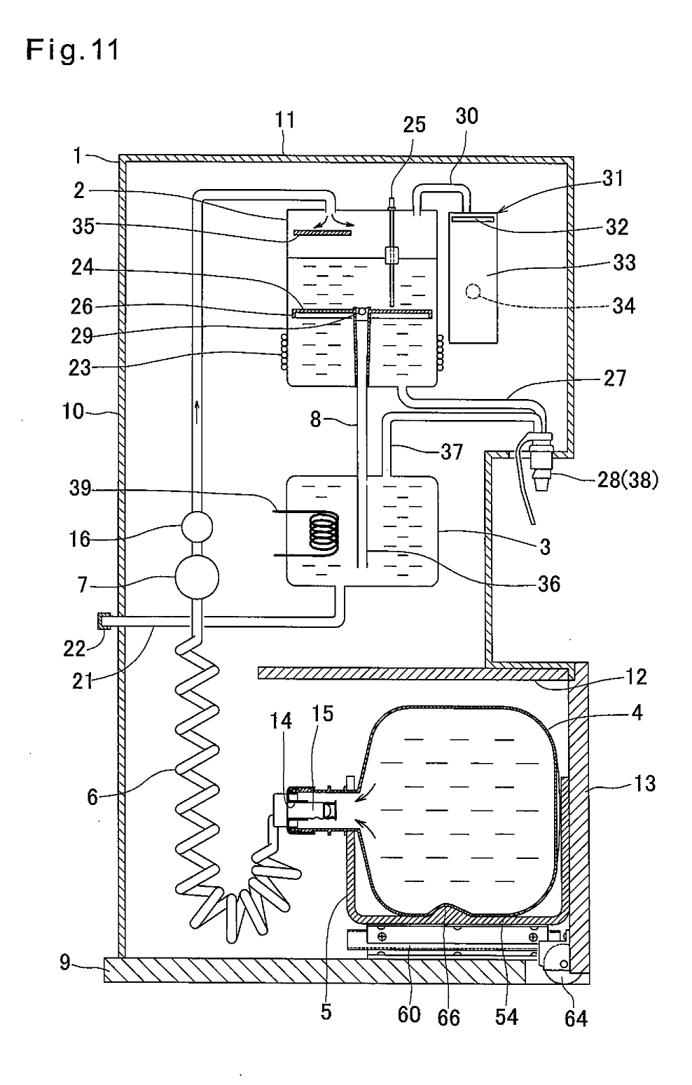

In the above mentioned embodiment, an example of the water dispenser is described, in which the water bottle 4 is disconnected from the raw water pumping pipe 6 when the bottle receiver 5 is pulled out of the housing 1, and the water bottle 4 is connected to the raw water pumping pipe 6 when the bottle receiver 5 is stowed in the housing 1. However, as shown in FIG. 11, the present invention is also applicable to a water dispenser in which the water bottle 4 maintains the connection to the raw water pumping pipe 6 when the bottle receiver 5 is pulled out of the housing 1. While FIG. 11 shows an example of the water dispenser in which a spiral tube capable of expanding and contracting is used as the raw water pumping pipe 6, a flexible tube having a slack sufficient for following the movement of the bottle receiver 5 can also be used as the raw water pumping pipe 6.

### DESCRIPTION OF SYMBOLS

4 water bottle
5 bottle receiver
6 raw water pumping pipe
7 pump
14 water outlet port
40 trunk portion
41 bottom portion
42 shoulder portion
43 neck portion
54 bottle mounting board
66 protrusion
67 slope
68 slope

1. A water dispenser comprising:
a replaceable water bottle comprising: a hollow cylindrical trunk portion formed flexible so as to be collapsible as an amount of water remaining in the water bottle decreases; a bottom portion provided at one end of the trunk portion; and a neck portion provided at another end of the trunk portion through a shoulder portion; wherein the neck portion is provided with a water outlet port;
a bottle receiver having a bottle mounting plate configured to support the trunk portion of the water bottle from below, with the neck portion of the water bottle directed horizontally;
a raw water pumping pipe configured to be connected to the water outlet port of the water bottle; and
a pump provided in the raw water pumping pipe and configured to pump out drinking water from the water bottle;
wherein a protrusion is provided on an upper surface of the bottle mounting plate, and the protrusion is configured to induce a portion of the trunk portion of the water bottle in contact with the bottle mounting plate to be folded inward when the water bottle is collapsed.

2. The water dispenser according to claim 1, wherein the protrusion is formed to extend intersecting a middle of the trunk portion of the water bottle.

3. The water dispenser according to claim 1, wherein the protrusion has an upper surface formed with a slope sloping downward from an apex of the protrusion toward the water outlet port of the water bottle, and a slope sloping downward from the apex of the protrusion in a direction away from the water outlet port of the water bottle, and wherein an angle of inclination of the slope sloping downward from the apex of the protrusion in the direction away from the water outlet port of the water bottle is set to 30° or less.

4. The water dispenser according to claim 1, wherein the trunk portion of the water bottle is made of PET resin.
